(19) United States
(12) Patent Application Publication
(10) Pub. No.: US 2012/0017098 A1
(43) Pub. Date: Jan. 19, 2012

(54) Computer Memory With Cryptographic Content Authentication

(76) Inventor: Phillip Martin Hallam-Baker, Medford, MA (US)

(21) Appl. No.: 13/176,194

(22) Filed: Jul. 5, 2011

Related U.S. Application Data
(60) Provisional application No. 61/364,164, filed on Jul. 14, 2010.

(51) Int. Cl. G06F 12/14

(52) U.S. Cl. 713/193

(57) ABSTRACT

A computer memory with cryptographic content authentication that provides a means of verifying that the contents of the memory are those intended.

Said authentication code may be calculated directly from some or all of the contents of the stored memory or indirectly with respect to a trust statement used to establish the validity of a digital signature calculated over some or all of the contents of the stored memory.

### CROSS-REFERENCE TO RELATED APPLICATIONS

This application claims the benefit of U.S. Provisional Application No. 61/364,164, filed on 14, Jul. 2010 under 35 U.S.C. 119(e), the entire contents of which are incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of computer data storage. More particularly, the present invention is in the technical field of establishing the integrity of stored data.

One of the biggest challenges in the field of computer security is determining if the expected contents of a computer memory are the actual contents.

For example, the operation of a device such as a telephone, camera, automobile control system or laptop computer may depend on program code contained in a memory system installed during manufacture. Since the contents of the memory system have no impact on the physical appearance of the memory, it is not possible to verify that the device has the correct program code by means of a visual inspection.

In particular when a ‘Flash ROM’ memory is employed in an article of manufacture that subsequently requires a modification to the program code, there is currently no reliable means of distinguishing an item that has the correct code from one that does not without turning the device on to make a version number or other revision code visible.

The importance of this problem is increased where the function of the device is such that it may allow for compromise of another system.

In particular, USB ‘thumb drives’ have become a cheap and convenient means of distributing software, data and other digital goods at trade shows. But in certain instances, compromise of the machines used to program the devices before distribution has resulted in devices being distributed that attempt to infect a host PC with malware when inserted. There being no reliable means of determining whether such a thumb drive is so infected (by visual inspection or other means) prior to insertion in the computer, all such items must be considered suspect.

Another instance in which this problem is of particular concern is in situations where the behavior of the device itself constitutes a security concern.

In particular, a modern chemical plant typically employs electronic control systems comprising many thousand different components manufactured in upwards of twenty different countries. It is not cost-effective for such plants to employ systems to establish the provenance of such components and the possibility of malicious tampering in the supply chain can never be excluded.

### SUMMARY OF THE INVENTION

A computer memory with cryptographic content authentication provides a self-contained means of verifying that the contents of a computer memory are those intended.

The memory provides a computer-readable, non-forgeable indication of the memory contents. Some or all of the memory contents are analyzed using a cryptographic function to produce a authentication code that may be verified through use of a communication means.

In the case that the memory contents are modified, the old Verification Code becomes invalid and is discarded. Depending on the application, the memory storage operation of the device may continue unaffected or be restricted or completely disabled until calculation of the new Verification Code has completed.

In order to better secure the authentication code against a replay attack, the authentication method may optionally include a ‘challenge value’ known as a nonce.

In one embodiment, the communication means is an electrical, optical, wireless or other means providing for communication between devices, for example computers. For example communication may be effected by means of the computer memory bus or a network interface such as Ethernet.

In another embodiment the communication means is a visual display that is a part of or connected to the memory device. The device thus provides a direct, human-readable means of verifying the memory contents.

The Verification Code may be displayed continuously or on request.

Such a display may use a passive display technology such as a gyricon display that does not require power to maintain the display contents. Such a device permits the contents of the memory to be verified by visual inspection without applying power to the device.

In yet another embodiment, multiple communication means are employed to provide for both machine and human verification of some or part of the memory contents.

For example: Alice wishes to determine that her desktop computer is using the correct initial ‘bootstrap’ code (commonly referred to as a BIOS). To ensure that this is the case she uses a tool that takes a removable memory device providing visual verification of its contents and loads the correct code into it. The removable memory device is then installed in the desktop computer and may be inspected periodically the check that the contents have not been modified.

A memory device that provides visual verification of the actual contents of the device has many applications but has the operational disadvantage that a human auditor attempting to verify the device must know the particular code that should be displayed for that particular device. In a large enterprise with many thousands of different devices it is more convenient for the codes displayed on each device to be the same.

In an alternative embodiment, the memory device is configured with at least one data structure referred to herein as a Trust Statement that defines the validation criteria for verifying the memory contents. If the contents of the device memory are consistent with the specified validation criteria, the device displays a authentication code for at least a part of the data structure specifying the validation criteria, either in addition to or in place of the authentication code for the memory contents. If the contents of the device memory are not consistent with the specified validation criteria the device may provide an error report on the display and may refuse to function as a memory device.

For example, Bob is the manager of a computer network comprising many hundred computers. Although each computer may require a different bootstrap code to be loaded, it is highly desirable for all the computers to display the same authentication code. To ensure this is the case a digital signature mechanism is used to verify the integrity of the bootstrap code and the authentication code is calculated from the data used to validate the signature key used to verify the bootstrap code. To program a removable memory device for a specific machine, Bob uses a tool that loads it with the correct code, a corresponding digital signature and the validation data required to establish the validity of the digital signature.

At the start of each week a new random challenge code is generated and distributed to every network device. Any device that does not present the correct authentication code may be identified as compromised (whether through malice or malfunction). The compromised devices may then be discarded or reprogrammed as appropriate or as directed by site policy.

In a further improvement of the invention, at least a part of the contents of the device are protected against modification after the device is initialized, this process being referred to herein as the memory contents being ‘locked’. This feature being commonly known as a ‘One Time Programmable’ (OTP) memory, although those of ordinary skill will understand that the important criteria for the purpose of the present invention being that at least a part of the memory contents of the device cannot be modified after they are fixed. The number of times the memory contents can be modified before they are fixed is not critical.

For example, Carol is the manager of a computer network similar to that managed by Bob. The removable memory device she employs for this purpose has a partition that can be locked. When initialized for use in a machine, the validation data used to establish the validity of digital signatures is written to the lockable part of the memory storage and locked. The bootstrap code itself and the digital signature are written to a partition that allows multiple write operations.

This configuration allows Carol to modify the bootstrap code stored in the memory device as required but it is only possible to load bootstrap code that has been digitally signed with a public key that is consistent with the Trust Statement.

For example, Doug's Design Corporation designs and sells industrial automation equipment. As Doug's Design Corporation does not have the ability to assemble the equipment, this task is outsourced to Edward's Engineering Inc. In order to sell the equipment to Fred's Foundry, Doug's Design Corporation is required to attest that the device is known to behave in accordance with regulatory requirements. The computer memory with authentication of contents allows Doug's Design to provide the necessary attestation even though Doug's Design did not oversee the production, assembly or distribution of the device.

### BRIEF DESCRIPTION OF THE DRAWINGS

FIG. 1 is a block diagram of a device with both machine and human verification means.

FIG. 2 shows an isometric view of removable computer memory with display for visual verification of the memory contents.

FIG. 3 shows the use of a static trust statement to establish the integrity of the memory contents.

FIG. 4 shows the use of a static trust statement to establish the integrity of the memory contents in conjunction with a Public Key Infrastructure (PKI).

### DETAILED DESCRIPTION OF THE INVENTION

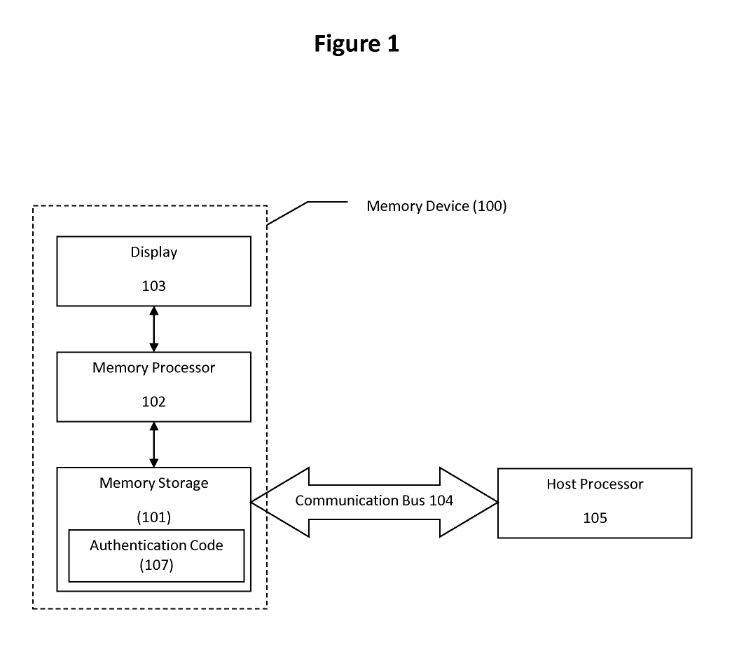

Referring to FIG. 1, A computer memory device (100) may provide authentication of all or part its memory storage (101). The memory processor (102) calculates the authentication code by means of a specified cryptographic function. Once calculated the authentication code is communicated to the display means (103) and reserved locations in the memory storage (107) allowing the value to be read by the host processor (105) by means of a communication bus (104).

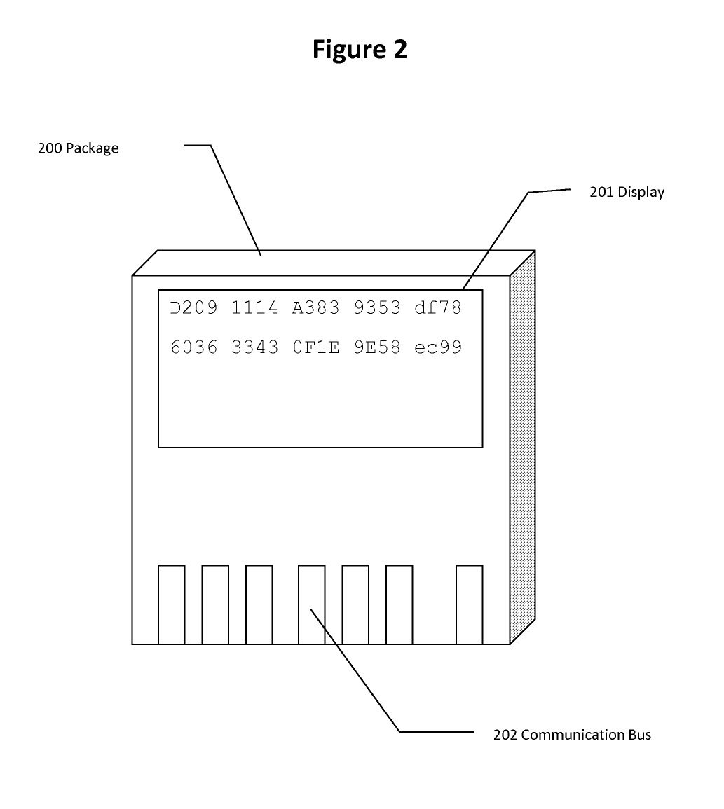

A computer memory with cryptographic content authentication may be realized as a fixed or removable component in a computer system. FIG. 2 shows an embodiment as a removable memory device in which the package (200) has display (201) and communication bus (202) components. A wide variety of formats are employed for such removable storage media, including but not limited to Compact Flash, Secure Digital, Memory Stick, each of which may be realized in numerous variants with respect to speed, memory capacity, size, etc.

In one embodiment, the cryptographic function used to verify the integrity of the memory storage contents is a Message Digest (MD) value or a Message Authentication Code (MAC) value calculated over all or part of the memory storage contents.

In an alternative embodiment, the cryptographic function used to verify the integrity of the memory storage contents is a Message Digest (MD) value or a Message Authentication Code (MAC) value calculated over all or part of the memory storage contents and additional data comprising a ‘challenge value’.

In yet another embodiment, the structure of the cryptographic function used to establish the integrity of the memory storage contents is structured so as to make recalculation of the authentication code more efficient when partial modification of the data occurs. For example Merkle teaches the use of a ‘hash tree’ in which the data from which a message digest value is to be calculated is divided into two or more partitions and intermediate message digest calculated for each partition and stored and the message digest for the whole being calculated from the intermediate message digest values. The same scheme may in turn be applied to the calculation of the message digest value for individual partitions.

Extended Embodiment Providing Indirect Verification With Respect to a Trust Statement.

In an improved scheme, the memory device reports on the validity of the memory contents with respect to a data structure that defines the validation criteria for verifying the memory contents. The corresponding authentication code being calculated over at least a part of said data structure.

For the purposes of this description, the data structure that defines the validation criteria for verifying the memory contents is referred to as a Trust Statement and the part of the trust statement that is used in the calculation of the authentication code is referred to as a Trust Root.

Such a trust statement may be implemented using a digital signature scheme such as that taught by Rivest. Alternatively the invention may be implemented using Message Authentication Codes and an equivalent Symmetric Key Infrastructure.

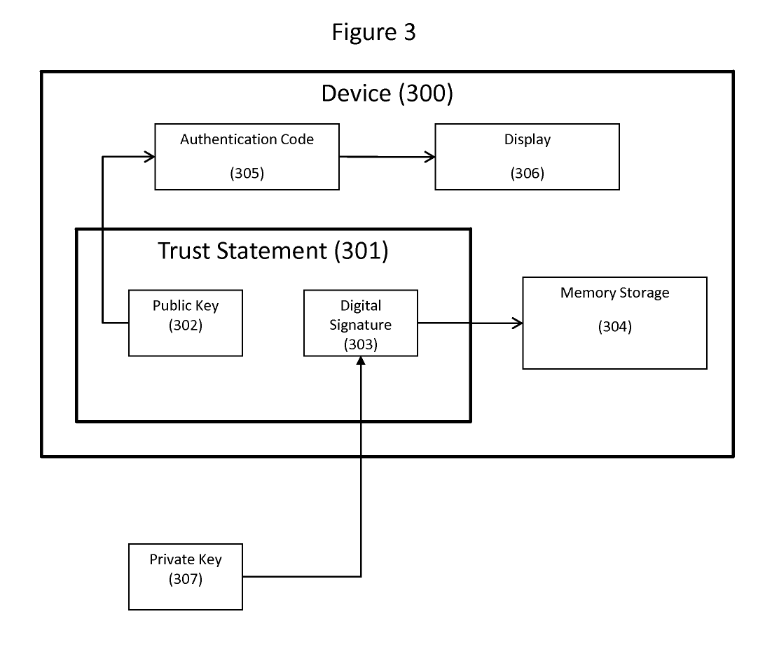

FIG. 3 shows a simple example of such a configuration. The Device (300) contains a Trust Statement (301), a Memory Storage (304) and a Display (306). The Trust Statement in turn contains a Public Key (302) a Digital Signature (303).

If verification of the Digital Signature with at least a part of the Memory Storage under the Public Key results in the result ‘valid’ the device calculates a Verification Code (305) that is presented on the Display.

Since a valid digital signature can only be generated using the Private Key (307) corresponding to the Public Key, it follows that only those parties with access to the corresponding private key can create the Trust Statement necessary to cause the device to display the corresponding Verification Code for a particular Memory Storage configuration.

Use of Public Key Infrastructure (PKI) or an assertion infrastructure such as Security Assertion Markup Language (SAML), Kerberos or similar cryptographic key management infrastructures affords additional operational conveniences.

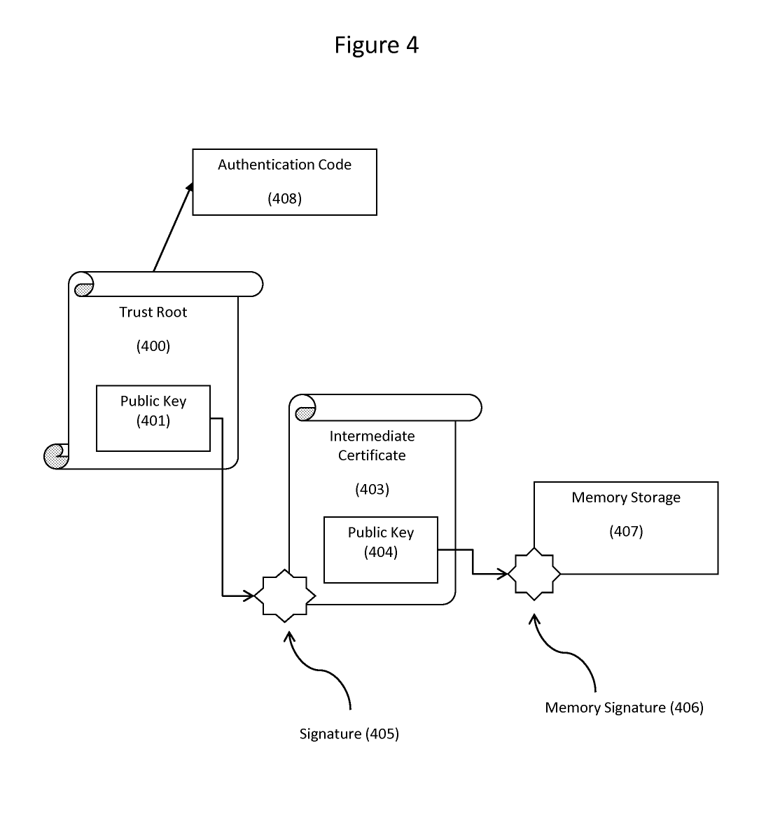

FIG. 4 shows an example of such a configuration. The Trust Statement consists of a Trust Root (400), an Intermediate Certificate (403) and a Memory Signature (406). The Trust Root is an X.509 Digital Certificate and contains a Public Key (401). The Intermediate Certificate contains a signature that is validated by the Public Key of the Trust Root (401) and a Public Key (404) which in turn validates the Memory Signature (406), being a Digital Signature of at least a part of the contents of the Memory Storage (407).

If the Memory Signature is valid, the device displays a Verification Code that is calculated from at least a part of the Trust Root.

A particular advantage to the use of a Trust Statement is that it allows a memory device to be configured in such a way that it will only return data whose integrity can be established with respect to the Trust Statement. The practical consequence of this feature is that a computer system whose bootstrap code is stored in such a memory will start if and only if the integrity of the bootstrap code can be verified with respect to a Trust Statement whose integrity may be verified by machine or visual inspection.

In an alternative embodiment, the Trust Statement or a part thereof may be locked against modification or erasure after it is fixed. This embodiment permits a device to be limited to contain only data that meets the authentication criteria set out in the Trust Statement.

Persistent Display Means

Presentation of the authentication code to a human user may be effected by any display technology including but not limited to LED, LCD or Cathode Ray Tube display.

Use of a passive display technology such as a gyricon display, electrowetting display or electrophoretic display allows the authentication code to be verified even when the device is not powered or is not installed.

### Equivalent Embodiments

The practitioner of ordinary skill in the art will understand and comprehend that the devices and methods described may be achieved through numerous equivalent implementations.

For example the practitioner of ordinary skill in the art will understand and comprehend that any cryptographic message digest function including but not limited to MD5, SHA-1 or SHA-2 may be employed for the purpose of generating Message Digest based authentication codes and any cryptographic Message Authentication Code including but not limited to HMA-SHA1 or HMAC-SHA2 may be employed for the purpose of generating Message Authentication Code based authentication codes.

The practitioner of ordinary skill in the art will further understand and comprehend that the authentication code may be truncated to present only part of the value resulting from the application of the cryptographic function.

I claim:

1. An apparatus comprising:
a. memory;
b. at least one processor; and
c. at least one display,
that calculates one or more authentication codes as a function of at least a part of the contents of the memory means as input and outputs at least one of said authentication codes via at least one display.

2. An apparatus according to claim 1 in which the display continues to present the last output when the device is powered down.

3. An apparatus according to claim 1 in which at least one authentication code is calculated by means of a cryptographic message digest function.

4. An apparatus according to claim 1 in which at least one authentication code is calculated by means of a cryptographic message authentication code function.

5. An apparatus according to claim 1 in which at least one authentication code is calculated by means of a Merkle tree.

6. An apparatus comprising:
a. memory;
b. at least one processor; and
c. at least one means of communication
in which the device receives a challenge value via a communication means and calculates one or more authentication codes as a function of at least a part of the contents of the memory means as input and outputs at least one of said authentication codes via at least one communication means.

7. An apparatus according to claim 6 in which a communication means is a computer bus.

8. An apparatus according to claim 6 in which a communication means is a computer network.

9. An apparatus according to claim 6 in which at least one authentication code is calculated by means of a cryptographic message digest function.

10. An apparatus according to claim 6 in which at least one authentication code is calculated by means of a cryptographic message authentication code function.

11. An apparatus according to claim 6 in which at least one authentication code is calculated by means of a Merkle tree.

12. An apparatus according to claim 6 in that additionally comprises a display.

13. An apparatus comprising:
a. memory;
b. at least one trust statement;
c. at least one processor; and
d. at least one display;
that calculates one or more authentication codes as a function of at least a part of the contents of the memory means as input, determines if at least one authentication code is consistent with at least one trust statement and outputs a result dependent on the result of that determination to a display.

14. An apparatus according to claim 13 in which the trust statement is authenticated by means of a digital signature.

15. An apparatus according to claim 14 in which the trust statement contains at least one digital certificate.

16. An apparatus according to claim 13 in which at least one authentication code is calculated by means of a cryptographic message digest function.

17. An apparatus according to claim 13 in which at least one authentication code is calculated by means of a cryptographic message authentication code function.

18. An apparatus according to claim 13 in which at least one authentication code is calculated by means of a Merkle tree.

19. An apparatus according to claim 13 in which the result displayed in the case that the authentication code is determined to be consistent with a trust statement is a function of the trust statement.

20. An apparatus according to claim 19 in which the result displayed in the case that the authentication code is determined to be consistent with a trust statement is also a function of the memory contents.
